(19) United States
(12) Patent Application Publication
(10) Pub. No.: US 2021/0079609 A1
(43) Pub. Date: Mar. 18, 2021

(54) CONVERTIBLE SHOVEL

(71) Applicant: Richard SOKAS, La Grange, IL (US)

(72) Inventor: Richard SOKAS, La Grange, IL (US)

(21) Appl. No.: 17/024,821

(22) Filed: Sep. 18, 2020

Related U.S. Application Data
(60) Provisional application No. 62/902,075, filed on Sep. 18, 2019.

(51) Int. Cl. E01H 5/02; A01B 1/02

(52) U.S. Cl. CPC E01H 5/02; A01B 1/022

(57) ABSTRACT

A shoveling and plowing device. The device may include two blades connected to a shaft. The two blades may be hinged and may be adjusted via a second, lower handle on the shaft. The adjustment may allow for the device to be used as a shovel, or the blades may be adjusted into a V-shape such that the device may be efficiently used as a plow. A wheel may be affixed to a lower portion of the device and may assist in pushing the device or lifting a load. The wheel may optionally be rotatable. The rotatable wheel may assist in navigating and maneuvering the device. The wheel may act as a fulcrum to assist in lifting the device when loading. Since the wheel is a rotatable fulcrum, it may assist the user in lifting a load and depositing it to the side.

### CROSS-REFERENCE TO RELATED APPLICATIONS

This application claims priority to U.S. Provisional Patent Application No. 62/902,075, filed Sep. 18, 2019, the disclosure of which is hereby incorporated by reference in its entirety.

### FIELD OF INVENTION

An apparatus and system for shoveling and plowing a surface is disclosed.

### BACKGROUND

Moving snow from a driveway, sidewalk, or yard can be a grueling process. Carrying heavy loads with a shovel can cause back pain and injury. A shovel may take multiple passes and an extensive period of time to clear large amounts of snow. Shovels typically cannot be used to push snow due to their shape. Shovels are shaped to scoop snow and hold the snow to be carried elsewhere. As a result, typical shovels bend inwards to allow for maximum scooping. When pushing snow with a typical shovel, the user may experience a significant amount of resistance due to the angle and shape of the shovel. When snow is pushed with a shovel, the majority of the snow accumulates in the center of the shovel, and the amount of force required to push the snow increases.

In contrast, a snowplow is typically curved outwards, in the opposite direction of a shovel, allowing snow to travel to the sides when pushed. This allows portions of snow to be cleared by pushing snow forward and to the sides of the plow, as opposed to accumulating in front. A plow may be convenient for clearing paths, especially in straight lines. However, it may be difficult or impossible to lift snow with most plows. Snowplows have open sides that allow snow to fall out and are often angled to force snow out of the sides as opposed to keeping the snow in the front of the plow. As a result, lifting snow with a plow will result in most of the snow falling off the sides.

Completely clearing large areas often requires multiple people working together with shovels or heavier machinery such as a snowblower or motorized snowplow. Access to heavy machinery may not be feasible nor economical in most places. These machines can be expensive. They typically require an energy source to run and cannot be used when the fuel runs out.

### SUMMARY

According to an exemplary embodiment, a convertible shovel may be provided. The convertible shovel may have a body, which may be an elongated shaft. The convertible shovel may also have an upper handle disposed at a first end of the body, at least two blades disposed at a second end of the body, which may be connected by a hinge, and a lower handle slidably arranged on the body and connected to each of the at least two blades by at least one support bar. The lower handle may be capable of adjusting the at least two blades between a hinged plow position and a straight shovel position by sliding along the body and adjusting the at least one support bar.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a plow/shovel device in a configuration optimal for shoveling.

FIG. 2 is an exemplary rear view of the blades of the plow device.

FIG. 3 is an exemplary embodiment of a plow in a configuration optimal for plowing.

FIG. 4A is an exemplary embodiment of the lower handle of the device.

FIG. 4B is an exemplary embodiment of the wheel adjustment mechanism.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

A convertible shovel or a shoveling and plowing device may be provided. The device may include two blades connected to a shaft. The two blades may be hinged and may be adjusted via a second, lower handle on the shaft. The adjustment may allow for the device to be used as a shovel, or the blades may be adjusted into a V shape such that the device may be efficiently used as a plow. A wheel may be affixed to a support leg, which projects from a lower portion of the device and may assist in pushing the device or lifting a load. The wheel may operate as a maneuvering assistance element and may optionally be a rotatable wheel. The wheel may act as a fulcrum or pivot point for navigating and lifting the shovel or plow and may facilitate navigation of obstacles.

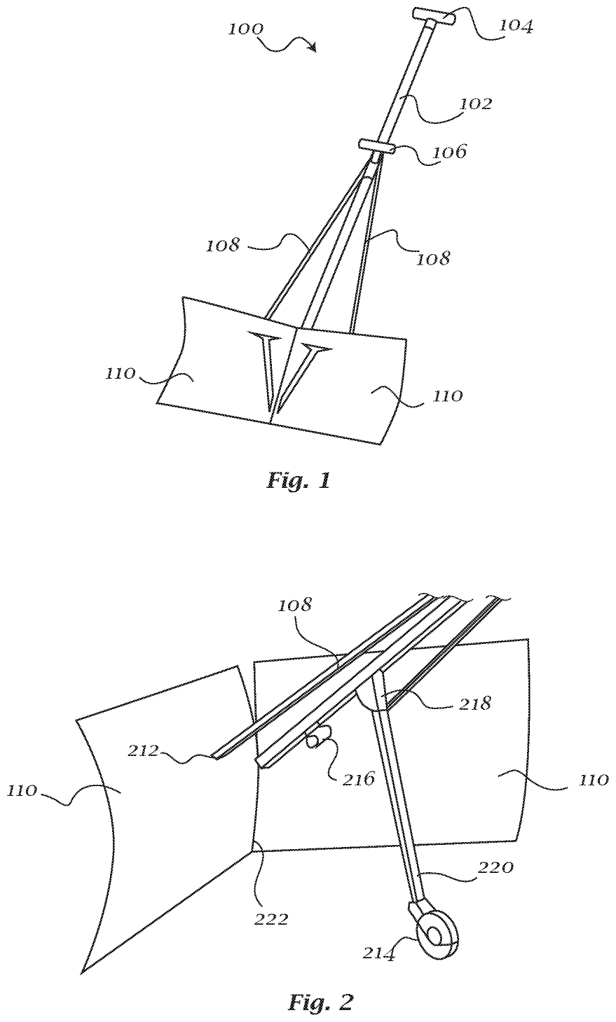

A convertible shovel or adjustable shoveling and plowing device 100 which allows for both plowing and shoveling may be disclosed. Referring to exemplary FIG. 1, the adjustable shoveling and plowing device 100 may be shown in the shoveling position. The shaft 102 may be the body of the device. According to some exemplary embodiments, shaft 102 may be an elongated cylindrical pole. Other components may be attached to the shaft 102. An upper handle 104 may be attached to a top end of shaft 102 and may allow for the device to be easily manipulated in several directions. The device may have a pair of adjustable plow blade portions 110 movable by a set of retraction or support bars 108 and a hinge 222 on the rear side, between the blade portions 110. The angle of the hinge may be adjusted by a lower handle 106 located along the length of the shaft 102. According to some exemplary embodiments, lower handle 106 may be located proximate a mid-point of shaft 102. The lower handle 106 may activate a spring-loaded locking mechanism which may allow for the linkage to be adjusted into a different position. A wheel 214 may be adjustably affixed to shaft 102. A clip 216 attached to shaft 102 may secure the wheel 214 when in a closed or retracted position, as discussed below. The wheel may extend from the shaft 102 by way of a wheel shaft 220.

The device may be configured in multiple secure positions. Exemplary FIG. 1 may show the device in the shoveling position, which may be substantially open and straight. In the shoveling position, the blades 110 of the plow may form a straight surface to allow for optimal scooping and shoveling of snow, as would be understood by a person having ordinary skill in the art. The straight surface may be curved concavely from a top edge to a bottom edge. When in the shovel position, the blades of the plow may be at an angle such that the snow is not inclined to fall from the sides of the blades 110 and instead remain on top, allowing for transportation of the snow.

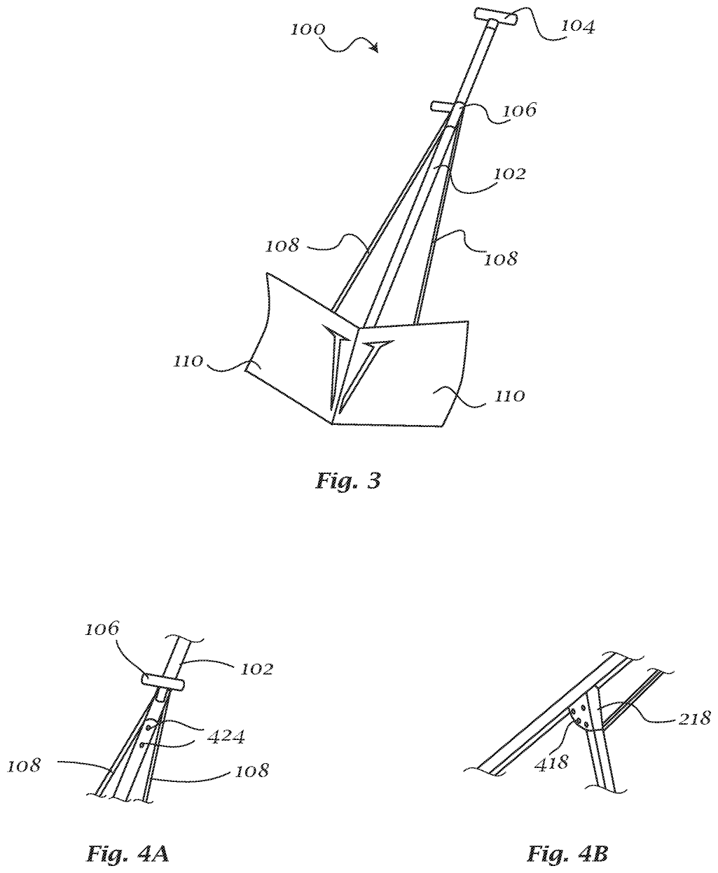

Referring now to exemplary FIG. 3, the snow plowing device may be shown in the plowing position. The adjustment handle 106 may be configured to slide along the shaft 102 in a forward or backward motion. When the handle 106 is pulled backward, the blades of the device 110 may be angled such that they form a convex “V” shape. The V-shape may be optimal for plowing snow. A V-shape may force snow to the sides of the plow, instead of accumulating in front of it. A user may experience less resistance pushing snow when the device is in such a V shape, as opposed to using the device in the open position. The V shape may be further adjusted to create a larger or smaller angle. A smaller angle may create a narrower path but may also produce less resistance than a larger angle.

A user may create a narrow path with a smaller angle, then may implement additional passthroughs of the same area with incrementally larger angles on the blade to create incrementally wider paths. This method of incrementally increasing the angle may allow a user to plow a path without requiring large amounts of labor on each pass through. This may be particularly helpful for a user who lacks the stamina or strength to push large amounts of snow to clear a wide enough path in one pass.

In an exemplary embodiment, the blades may be flared in such a way that the snow is thrown to the sides in a more efficient manner. This may be accomplished by angling the edges of the blades to maximize the path of the snow. The flared wings may further embody an enhanced curl. The curl may guide the snow to a path of less resistance off to the side of the blades, as opposed to in front, where snow ordinarily piles up. The flared wings may allow the blades to move snow to the side when in the plow position but may still hold snow in the middle when in the shovel position.

Referring to exemplary FIG. 2, the rear side of the blade assembly may be shown. The rear side of the blades may be fitted with a central hinge 222 in between the two blades 110. The hinge may secure the blades to the shaft 102 while allowing the blades to rotate with respect to the plowing angle. The plowing angle may be adjusted by the control arms 108 which may connect to the blades 110 with another angle adjustable hinge 212. On the opposite side, the control arms 108 may connect to the lower handle 106. Therefore, when the handle 106 is pulled back, the control arms 108 and thus the blades 110 are also pulled back. The center of the blades 110; however, may retain the same position since the shaft 102 may be in a fixed position relative to the control arms and handle. Since the shaft 102 may be fixed in a forward position and the control arms 108 and sides of the blades 110 may be pulled back, a V shape may be created.

A wheel 214 may be fitted towards the bottom of shaft 102, as shown in FIG. 2. The wheel may be foldable and adjustable with respect to a hinge assembly 218. Hinge assembly 218 may optionally be a locking hinge assembly. The wheel shaft 220 may be hingedly affixed to the shaft 102 and the wheel 214 may be disposed on an end of the wheel shaft 220 opposite the shaft 102. When the device is in the shovel position, the wheel may be folded closed and secured to a clip 216 on the bottom of the shaft 102 to allow for a user to scoop snow from an optimal angle. Alternatively, the wheel 214 may be kept open in the open position so as to act as a fulcrum, which may facilitate the lifting and shoveling process.

Still referring to exemplary FIG. 2, the wheel 214 may provide stability when the device is in the plow position. The wheel 214 may assist a user in navigating and maneuvering the device. By lifting part of the device, the wheel may bear all or part of the weight of the device as well as the material being moved. Typical shovels and plows may produce friction between the device and the ground. Friction may be reduced significantly through the use of the wheel 214, thus reducing the force required to push the device. The wheel 214 may allow an even surface to be plowed efficiently, by supporting the blades 110 just above the surface. The wheel 214 may be used as a fulcrum, allowing a user to push the device in the plow position at multiple different angles, depending on the level of snow and the texture ahead.

A rotating type wheel 214 may be used. The rotating action of the wheel 214 may assist in turning the device to a specific direction with ease. The wheel may rotate to allow the device to be manipulated to any direction. The rotating action may be especially advantageous for navigating around obstacles. Further, the wheel may be used as a fulcrum in order to accurately shovel around or over obstacles. Since the wheel may be used as a fulcrum, the rotating wheel may provide a mechanism for a user to push, move, or scoop snow to a location other than in front of the device, such as to the side.

The wheel 214 may be adjusted to multiple different positions. The different positions may accommodate users of different heights as well as surfaces that require different angles. The height of the wheel 214 may be adjusted with position locking pins 218, as shown in exemplary FIG. 4B. According to an exemplary embodiment, the positions may vary along an approximately 90 degree or approximately 180 degree path from the shaft 102. Therefore, the wheel shaft 220 may be oriented substantially parallel to the shaft 102 with the wheel disposed proximate the blades, angled in relation to the shaft 102, substantially perpendicular to the shaft 102, or parallel to the shaft 102 with the wheel shaft disposed toward the upper handle. When not in use, the wheel may be locked into a clip 216 which may retain the wheel along the body or shaft of the device. Still further, the wheel 214 may be in an open, closed, or partially open position during use in a plow configuration and/or shovel configuration.

The lower handle 106 of the device may serve multiple functions. First, the user may adjust the shovel position by disengaging a locking mechanism, such as locking pins, and pushing or pulling the lower handle 106. The lower handle 106 may be pushed all the way forward to push the blades 110 into a shovel position or pulled back, towards the user, to pull the blades 110 into a V shape for plowing. In an exemplary embodiment, multiple positions are contemplated such that the blades may be adjusted to be wider or narrower, depending on the application. Further, the lower handle 106 may provide a grip for the user to grasp device 100. By gripping at a lower location, the user may more efficiently lift and move large amounts of snow when using the device in the shovel position. When in the shovel position, the lower handle 106 may be locked into the shovel position, allowing for the user to firmly grip the handle without the handle 106 slipping or moving into a different position. The handle 106 may be shaped in such a way that it may be easily gripped from above. In an exemplary embodiment, the lower handle 106 may be in a T shape to optimize gripping power and comfort. Furthermore, in a plow configuration, the lower handle 106 may provide an additional pushing location, which may provide leverage for pushing the device 100 forward, but also keeping the plow blades 110 in contact with a surface, such as the ground or pavement.

Referring now to FIG. 4A, an exemplary blade locking mechanism may be shown. The lower handle 106 may be connected to control arms 108. The control arms 108 may connect to an outer portion of the blades 110. When the lower handle 106 is pulled back, the lower handle 106 may slide along the shaft 102 of the device, pulling the control arms 108 along with it. When the control arms 108 are pulled back, they may pull on the outside of the blades 110, bringing them in towards top handle 104 while the hinged center portion of the blades 110 is fixed in relation to top handle 104. As a result, the center portion of the blades 110 may be pointed forward while the outer portions of the blades may be pointed substantially rearwards. A locking mechanism or pin on the underside of handle 106 may be secured into the apertures 424 along the shaft 102. The pin may be spring loaded and may be compressed by a button or movement on handle 106. By securing the handle 106 into a higher aperture 424, the plow blades 110 may be more substantially angled for plowing. This may create a pointed V shape, with the apex of the V at the front, as seen in FIGS. 2 and 3.

Adjustable lower handle 106 may serve many functions. It may allow a user to quickly and easily transition between different angles. A user who is shoveling heavy snow may choose a narrower angle in order to decrease the resistance when pushing the plow. Then, the same user may choose a wider angle and plow the same path in order to widen the path without requiring an excess of force. The wider angle may be met with much less resistance after the ground has already been narrowly plowed. This method of plowing a path may be facilitated by the lower handle 106 because the lower handle 106 may allow the user to quickly adjust the plowing angle, as opposed to other plows which may settle for a fixed angle.

Referring now to exemplary FIG. 4B, the wheel adjustment pins may be shown. The wheel adjustment pins may utilize, for example, spring loaded pins which engage correspondingly sized apertures 418 to securely hold the wheel 214 in the desired angle. Exemplary FIG. 4B depicts a device with 3 apertures, however, any number of apertures may be contemplated in order to provide for a greater number of possible angles which may be useful for different applications.

According to some further exemplary embodiments, the wheel shaft and lower handle may optionally be engaged by a support, which may adjust the wheel shaft in sync with the lower handle, such that the wheel is retracted when the lower handle is in a shovel position (lower position) and is extended when the lower handle is in a plow position (higher position along the shaft 102).

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A convertible shovel comprising:
a body, being an elongated shaft;
an upper handle disposed at a first end of the body;
at least two blades disposed at a second end of the body, wherein the at least two blades are connected by a hinge;
a lower handle slidably arranged on the body and connected to each of the at least two blades by at least one support bar,
wherein the lower handle is configured to adjust the at least two blades between a hinged plow position and a straight shovel position.

2. The convertible shovel of claim 1, wherein a spring-loaded pin locking mechanism engages the lower handle to secure the lower handle in preset locations along the body.

3. The convertible shovel of claim 1, comprising a first blade and a second blade, wherein the lower handle is secured to the first blade by a first support bar and the lower handle is secured to the second blade by a second support bar.

4. The convertible shovel of claim 1, further comprising a wheel assembly affixed to the elongated shaft of the body.

5. The convertible shovel of claim 4, wherein the wheel assembly comprises a wheel shaft secured to the body and a wheel disposed on an end of the wheel shaft opposite the body.

6. The convertible shovel of claim 5, wherein the wheel shaft is secured to the body by a locking hinge configured to adjust the wheel shaft in relation to the body.

7. The convertible shovel of claim 6, wherein the locking hinge has preset orientations for the wheel shaft.

8. The convertible shovel of claim 6, further comprising a wheel clip disposed on the body between the wheel hinge and the at least one blade, wherein the wheel clip is configured to secure the wheel to the elongated shaft of the body.

9. The convertible shovel of claim 6, wherein the wheel is rotatable.

10. The convertible shovel of claim 1, wherein grips of the upper handle and lower handle are disposed perpendicular to the body.
